(19) United States
(12) Patent Application Publication
(10) Pub. No.: US 2021/0098158 A1
(43) Pub. Date: Apr. 1, 2021

(54) CABLE

(71) Applicants: FOXCONN (KUNSHAN) COMPUTER CONNECTOR CO., LTD., Kunshan (CN); FOXCONN INTERCONNECT TECHNOLOGY LIMITED, Grand Cayman (KY)

(72) Inventors: YANG-BO ZHENG, Kunshan (CN); JUAN ZHENG, Kunshan (CN); LU-YU CHANG, New Taipei (TW)

(21) Appl. No.: 17/033,619

(22) Filed: Sep. 25, 2020

(30) Foreign Application Priority Data
Sep. 30, 2019 (CN) 201921652562.9

(51) Int. Cl. H01B 11/18; H01B 1/02

(52) U.S. Cl. CPC H01B 11/1895; H01B 3/441; H01B 1/026; H01B 11/183

(57) ABSTRACT

A cable includes: a pair of core wires; an integrally extruded insulating layer covering the pair of core wires; a shielding layer covering the extruded insulating layer; and an outer insulating layer covering the shielding layer; wherein the pair of core wires are arranged longitudinally side by side and touch each other.

### BACKGROUND OF THE INVENTION

### 1. Field of the Invention

The present invention relates generally to a cable, and more particularly to a cable used to transmit high frequency signals.

### 2. Description of Related Arts

The high-speed signal cable in the prior art usually includes a pair of core wires, a metal shielding layer surrounding the pair of core wires, an insulating outer layer covering the metal shielding layer and a grounding wire set next to the metal shielding layer, the ground wire can be a pair or a single. Each of a pair of signal core wires includes an inner insulating layer and an inner conductor covered in the inner insulating layer.

China patent No. CN108376580A discloses a cable. The cable comprising a pair of signal core wires, extruded insulating layer surrounding the core wire, a metal shielding layer covering the insulating layer, an insulating outer layer covering the metal shielding layer and a grounding wire set next to the metal shielding layer, but the distance between the two core wires is relatively large, the position between the core wires is relatively unstable unfixed, and the overall space of the cable is large.

An improved cable is desired.

### SUMMARY OF THE INVENTION

A main object of the present invention is to provide a cable that, on the premise of keeping the impedance constant, reduces the distance between the two conductors, thereby reducing the overall wire diameter.

To achieve the above-mentioned object, a cable comprises: a pair of core wires; an integrally extruded insulating layer covering the pair of core wires; a shielding layer covering the extruded insulating layer; and an outer insulating layer covering the shielding layer; wherein the pair of said core wires are arranged longitudinally side by side and touch each other.

Compared to the prior art, the present invention has the advantage that the two core wires are in contact with each other so that the position between them is relatively fixed, and at the same time, it is covered with the extruded insulating layer outside the two core wires, so that it and the core wire becomes an integral structure. In the subsequent processing, the position of the two core wires is not easy to change. In this way, when the overall impedance and the relative position of the two core wires remain unchanged, the two core wires in contact with each other reduce the distance between the two conductors, thereby reducing the diameter of the overall cable, at the same time, the cable of the present invention has the ability to transmit high-speed data signals with a frequency greater than 40 GHz.

### BRIEF DESCRIPTION OF THE DRAWING

FIG. 1 is a cross-section view of the first embodiment of the cable of the present invention; and

FIG. 2 is a cross-sectional view of the second embodiment of the cable of the present invention.

### DETAILED DESCRIPTION OF THE PREFERRED EMBODIMENT

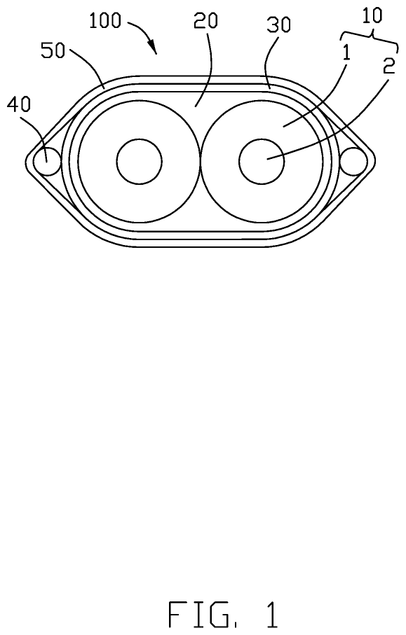

Referring to FIG. 1, which is the first embodiment of a cable 100 of the present invention. The cable 100 includes two core wires 10, an insulating layer 20, a shielding layer 30, a ground wire 40 and an outer insulating layer 50 in order from the inside to the outside. The insulating layer 20 covers the two core wires 10, the shielding layer 30 covers the insulating layer 20, and the outer insulating layer 50 covers the shielding layer 30. The ground wire 40 is located between the shielding layer 30 and the outer insulating layer 50

In this embodiment, the two core wires 10 are contact with each other and extend in the longitudinal direction. Each core wire 10 includes an inner conductor 1 and an inner insulating layer 2 covering the inner conductor 1, and the inner conductor 1 is used for transmitting high-speed signal. The inner insulating layer 2 of each core wire 10 is extruded and molded to cover the inner conductor 1. The inner conductor 1 may be one of a copper inner conductor, a silver-plated copper inner conductor, and a tin-plated copper inner conductor. The inner insulating layer can be one of PP (polypropylene), PE (polyethylene), Teflon (polytetrafluoroethylene), foamed PP, foamed PE, and foamed Teflon. The inner insulating layers 2 of the two core wires 10 are touched to each other. The two core wires 10 close to each other are covered with an insulating layer 20 that is extruded and molded and there is no air gap between the insulating layer 20 and the core wire 10. The two touched core wires 10 make the thickness of the two inner insulating layers 2 between the two inner conductors 1, in this way, the mutual position of the two inner conductors 1 is relatively fixed by the extruded insulating layer 20. In this way, the distance between the two inner conductors 1 is reduced on the premise that the relative position of the inner conductor 1 remains unchanged, thereby reducing the overall outer diameter of the cable. In addition, the extruded insulating layer 20 covers the two core wires 10 to form an integral structure to ensure that the relative positions of the two core wires 10 will not change during the subsequent manufacturing process. The extruded insulating layer 20 can be any one of PP, PE, Teflon, foamed PP, foamed PE, and foamed Teflon.

There are two ground wires 40, and the two ground wires 40 are respectively located on the left and right sides of the shielding layer 30. The shielding layer 30 can be any one of aluminum foil (AL/PET), double-sided aluminum foil (AL/PET/AL), copper foil (Cu/PET), double-sided copper foil (Cu/PET/Cu), semi-conductive tape and silver-plated copper foil. The shielding layer 30 is wrapped on the outside of the insulating layer 20 in a longitudinally coating way or wrapped on the outside of the insulating layer 20 in a spiral winding way. The outer insulating layer 50 can be provided as one layer or multiple layers, and its material can be PET (polyethylene terephthalate) tape.

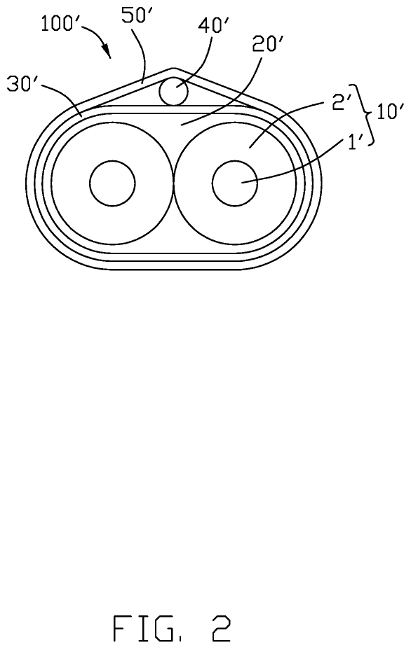

Please refer to FIG. 2, which is the second embodiment of the cable 100′ of the present invention. The cable 100′ comprises two core wires 10′, an insulating layer 20′ covering the two core wires 10′, a shielding layer 30′ covering the insulating layer 20′, an outer insulating layer 50′ covering the shielding layer 30′ and a ground wire 40′ arranged between the shielding layer 30′ and the outer insulating layer 50′. Compared with the first embodiment, there is only one ground wire 40′ in this embodiment, which is arranged in the upper middle of the two core wires on the upper side of the shielding layer 30′.

In the present invention, The core wire is formed by extruding the inner insulating layer outside the inner conductor 1, then through the second extrusion molding, the insulating layer is extruded and molded to cover the two core wires, and the two core wires are in contact with each other so that the position of the inner conductor is relatively fixed, the insulating layer integrally formed outside the two cores makes the cable a solid overall structure, and the position of the two core wires is not easy to change during subsequent processing. In addition, the cable of the present invention reduces the distance between two conductors while ensuring that the overall impedance remains unchanged, thereby reducing the outer diameter of the overall cable. The cable of the present invention has a high-speed data transmission capability with a signal transmission frequency greater than 40 GHz.

The above are only some of the embodiments of the present invention, but not all of the embodiments. Any equivalent changes to the technical solutions of the present invention by those skilled in the art by reading the description of the present invention are covered by the claims of the present invention.

What is claimed is:

1. A cable comprising:
a pair of core wires;
an integrally extruded insulating layer covering the pair of core wires;
a shielding layer covering the extruded insulating layer; and
an outer insulating layer covering the shielding layer; wherein
the pair of core wires are arranged longitudinally side by side and touch each other.

2. The cable as claimed in claim 1, wherein each of the core wires includes an inner conductor and an extruded inner insulating layer covering the inner conductor.

3. The cable as claimed in claim 2, wherein the inner conductor is selected from the group including a copper inner conductor, a silver-plated copper inner conductor, and a tin-plated copper inner conductor.

4. The cable as claimed in claim 2, wherein the inner insulating layer is selected from the group including PP, PE, Teflon, foamed PP, foamed PE, and foamed Teflon.

5. The cable as claimed in claim 1, further including at least one ground wire arranged between the metal shielding layer and the outer insulating layer.

6. The cable as claimed in claim 4, wherein the ground wire is located on the left and right side or the upper and lower side of the shielding layer.

7. The cable as claimed in claim 1, wherein the extruded insulating layer is selected from the group including PP, PE, Teflon, foamed PP, foamed PE, and foamed Teflon.

8. The cable as claimed in claim 1, wherein there is no air gap between the extruded insulating layer and the pair of core wires.

9. The cable as claimed in claim 1, wherein the shielding layer is selected from the group including an aluminum foil, a double-layer aluminum foil, a copper foil, a double-layer copper foil, a semi-conductive tape, and a silver-plated copper foil.

10. The cable as claimed in claim 1, wherein the shielding layer covers the extruded insulating layer in a spiral winding way or a longitudinal wrapping way.
